(19) United States
(12) Patent Application Publication
(10) Pub. No.: US 2025/0286297 A1
(43) Pub. Date: Sep. 11, 2025

(54) CONNECTOR WITH EXPANDING CONTACT

(71) Applicant: HARTING International Innovation AG, BIEL (CH)

(72) Inventors: Vivek R. Dave, Concord, NH (US); Vianney Grenez, San Francisco, CA (US); Sarah Southerland, Paxton, MA (US)

(21) Appl. No.: 19/069,806

(22) Filed: Mar. 4, 2025

Related U.S. Application Data
(60) Provisional application No. 63/563,338, filed on Mar. 9, 2024.

(51) Int. Cl. H01R 13/11; H01R 4/60; H01R 4/62; H01R 13/03; H01R 43/16

(52) U.S. Cl. CPC H01R 13/111; H01R 13/03; H01R 43/16; H01R 4/60; H01R 4/62

(57) ABSTRACT

An electrical contact having an inner conductor, an outer conductor and an intermediate element located between the inner conductor and the outer conductor. The material of the intermediate element has one or both of a higher electrical resistivity and a higher rate of thermal expansion than the material of both the inner conductor and the outer conductor. Methods of forming an electrical contact, and an electrical connector including an electrical contact are also disclosed.

This application claims the benefit of priority of U.S. Provisional Application No. 63/563,338, filed on Mar. 9, 2024. The entire contents of those applications are relied upon and incorporated herein by reference in their entirety.

### TECHNICAL FIELD

The present disclosure relates generally to electrical contacts and conductive materials for use in electrical contacts and related systems.

### BACKGROUND

Electrical connectors include contacts via which electricity is transmitted between the connectors. The contacts may include a pin of one connector and corresponding socket in the other connector that receives the pin, with physical engagement between the contacts enabling electrical conduction. The actual areas of conduction may be small, causing undesirable effects like energy loss, localized heating, higher temperatures, thermal expansion and inconsistent mechanical engagement of the contacts, for example.

### SUMMARY

In at least some implementations, an electrical contact having an inner conductor, an outer conductor and an intermediate element located between the inner conductor and the outer conductor. The material of the intermediate element has one or both of a higher electrical resistivity and a higher rate of thermal expansion than the material of both the inner conductor and the outer conductor. The intermediate element can be formed as an intermediate layer.

In at least some implementations, the material of the intermediate element has a lower yield strength than the material of the outer conductor.

In at least some implementations, the material of the intermediate element has a lower yield strength than the material of the inner conductor.

In at least some implementations, the intermediate element is bonded to one or both of the inner conductor and the outer conductor.

In at least some implementations, the intermediate element is contained in an insert that is removable from the inner conductor.

In at least some implementations, the intermediate element is formed from one or more of stainless steel, tin and copper. In at least some implementations, the intermediate element is formed from machinable copper with a coefficient of thermal expansion greater than that of pure copper. Machinable copper can be a copper alloy that is specially adapted to be machinable. Brass, for example, can be processed effectively by machine.

In at least some implementations, the intermediate element is tubular and has a central passage in which the inner conductor is received.

In at least some implementations, the intermediate element is formed from a different material than both the inner conductor and outer conductor, and is located between and separates the inner conductor and outer conductor such that the conductors are not in direct, physical contact with each other.

In at least some implementations, the intermediate element is provided in the form of a coating bonded to one or both of the inner conductor and the outer conductor.

In at least some implementations, the intermediate element is formed from an amalgam of a tin matrix with copper particles or silver particles.

In at least some implementations, the intermediate element is formed from semi-solid or thixotropic metal alloys.

In at least some implementations, the intermediate element is formed from an aluminum-silicon thixotropic alloy.

In at least some implementations, the intermediate element is formed from a tin alloy that includes spherical, copper particles.

In at least some implementations, the material of the intermediate element has a yield strength that is 5% to 50% greater than the material of the outer conductor or the inner conductor.

In at least some implementations, the material of the intermediate element has an electrical conductivity that is 5% to 50% lower than the material of the outer conductor or the inner conductor.

In at least some implementations, the outer conductor is part of a receptacle contact and includes a radially inner surface against which an outer surface of the intermediate element is received.

In at least some implementations, a method of forming a multiple material electrical contact, includes:
providing an outer contact that has a passage;
securing within the passage an annular intermediate element having an outer surface adjacent to a surface of the outer contact that defines the passage and an inner surface that defines a passage of the intermediate element; and
securing an inner conductor within the passage of the intermediate element, wherein the material of the intermediate element has one or both of a higher electrical resistivity and a higher rate of thermal expansion than the material of both the inner conductor and the outer conductor.

In at least some implementations, the inner conductor is a solid pin.

In at least some implementations, the inner conductor is annular and defines a socket of a receptacle contact.

In at least some implementations, an electrical connector comprises an electrical contact constructed or produced according to any of the foregoing implementations.

So formed, the electrical contacts described herein can help prevent localized increases in electrical contact resistance in a wide array of electrical contacts. The contacts may have increased contact pressure to improve electrical conductivity. The intermediate element can do one or more of: increase the contact force between mated electrical contacts; and make the contact force more consistent across a mated surface area (apparent area of contact). The contacts may provide a contact force that increases with increasing current, thereby lowering the contact resistance and providing a “self-tightening” mechanism whereby connection of the electrical contacts is improved with increasing current, at least within a range of current that occurs within given applications. Still other benefits and improvements may be achieved with contacts constructed as set forth herein.

### BRIEF DESCRIPTION OF THE DRAWINGS

The following detailed description of preferred implementations and best mode will be set forth with regard to the accompanying drawings, in which:

FIG. 1 is a partial cross-sectional view of an illustrative pair of mating electrical connectors including mating electrical contacts;

FIG. 2 is a fragmentary side view showing an area of engagement between an end of one electrical contact with a surface of a mating electrical contact;

FIG. 3 is an enlarged view of the area of engagement;

FIG. 4 is a fragmentary view of a surface of an electrical contact;

FIG. 5 is a diagrammatic side sectional view of mated electrical contacts including a cylindrical contact received within an annular contact;

FIG. 6 is an end view of the mated contacts of FIG. 5;

FIG. 7 is a side sectional view of the mated contacts;

FIG. 8 is a graph of compressive stress at different temperatures; and

FIG. 9 is a diagrammatic side sectional view of mated electrical contacts including a cylindrical contact received within an annular contact.

### DETAILED DESCRIPTION

FIG. 1 illustrates mating electrical connectors 10, 12 shown in a disconnected state. Each connector 10, 12 includes a housing 14, 16 and at least one electrical contact 18, 20 located at a fixed position relative to and in the respective housing. The connectors 10, 12 can be moved toward each other so that a portion of one housing 14, 16 is received by the other housing 14, 16 to assume a connected state in which the connectors 10, 12 may be removably coupled together (e.g., via a snap-fit feature) to form an electrical connection between aligned and mated pairs of electrical contacts 18, 20. When the electrical connection is formed, the electrical contacts 18, 20 are in physical contact with each other at respective and opposing contact surfaces 22, 24 at or along a contact interface. In the connected state, the mating connectors 10, 12 electrically connect conductors 26 (e.g., wires, conductive circuit traces, etc) of separate devices to carry electric current or signals between the connected devices.

In the illustrated example, the connectors 10, 12 are respective plug and socket connectors and the contacts 18, 20 are respective pin and receptacle contacts wherein the pin contacts 18 are arranged for conductive contact with the receptacle contacts 20 when received therein. Each electrical contact 18, 20 is formed from or includes a surface layer of an electrically conductive material (e.g., metal like copper or aluminum) and is arranged for electrical conduction therethrough when the connectors 10, 12 are in the connected state.

It is noted that the connectors 10, 12 and electrical contacts 18, 20 of FIG. 1 are merely examples of multitudes of styles of electrical connectors and contacts. The discussion below is related to materials for use in the electrical contacts of any type of connector or connection or, in some cases, conductors 26 interconnected by other connectors. These materials may be adapted for use, for example without limitation, in connectors or conductors through which relatively large amounts of power are transferred, through which relatively high-frequency AC current is carried, and/or in applications in which the electrical connection is subject to vibration, thermal cycling, or frequent connecting and disconnecting.

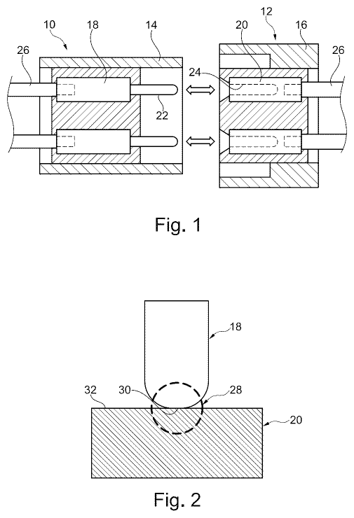

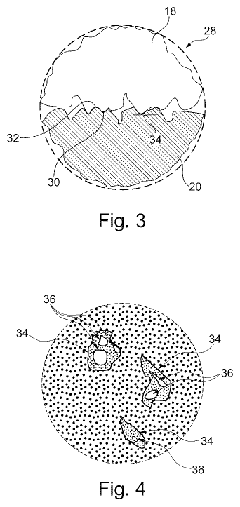

FIG. 2 is an enlarged cross-sectional view of a contact interface 28 shown between a free end 30 of a pin contact 18 and an end surface 32 of a receptacle contact 20. For simplicity, the sides of the receptacle contact 20 are not shown and just the end surface 32 is shown, although the discussion below relates equally to other surfaces of the contacts 18, 20. An apparent area of contact is shown in FIG. 2, and includes the entire surface area of the pin contact 18 that seems to be engaged with the corresponding end surface 32 of the receptacle contact 20. However, as shown in FIG. 3 which is an enlarged view of a portion of the apparent area of contact, and FIG. 4 which is a view of part of the surface of one of the contacts, the respective surfaces of the contacts 18, 20 are not perfectly smooth and include surface irregularities or asperities. The irregularities or asperities reduce the actual areas or points of direct engagement between the electrical contacts 18, 20, and actual areas of engagement define a load bearing contact area, and collectively separate areas 34, that is/are capable of bearing or transmitting load between the contacts. Further, in use or at least some implementations, not all of the load bearing contact areas 34 will actually transmit load due to, for example, presence of oxides or contaminants, or because they are otherwise unable to conduct reliably. The portions of the load bearing contact areas 34 that do transmit load define electrically conductive area(s) 36 that is/are a smaller total/combined area than that of the load bearing contact areas 34.

In view of the smaller areas that actually are conducting load therethrough, an increased resistance, sometimes called surface contact resistance occurs that impedes load transmission through the contacts 18, 20. Especially in (but not limited to) electrical systems carrying high current, high voltages or both, the contact resistance can be a significant factor in heating of electrical contacts that can lead to a decrease in contact performance over time. This may manifest in energy loss at the electrical contacts 18, 20, joule heating, signal noise, localized heating and hot spots that could cause arcing or other abnormal events, and thermal expansion which can increase the contact resistance and localized heating.

The magnitude of surface contact resistance can vary from electrical contact to electrical contact and in different applications due to a variety of factors. Representative factors include, but not limited to, the surface roughness of both contacts 18, 20, properties of the materials of the contacts, magnitude or distribution of contact force between the contacts, contact geometries and whether the contacts are sliding or stationary contact, contamination or degradation of the contact surfaces, and the presence of other materials like lubricants or cleaners (by way of non-limiting examples).

Also, thermal expansion can affect the contact forces (i.e., biasing forces) at the contact interface formed at the opposing, overlapped surfaces 22, 24 of mated contacts 18, 20. Such changes in contact force can change the effective contact resistance, especially in the presence of a thermal gradient. For example, the contacts 18, 20 may have different thermal conductance, heat transfer to other components or ability to transfer heat away from the contact interface. As a result, one contact 18 or 20 may be hotter and may thermally expand more than the cooler contact 18 or 20, and this can lead to loosening of the connection and an associated higher contact resistance.

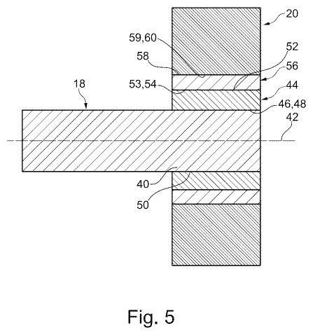

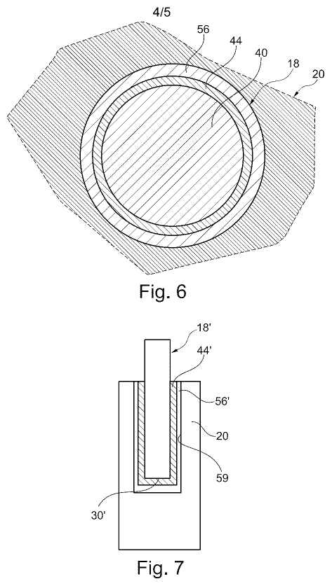

Referring now to FIGS. 5 and 6, a pin contact 18 is shown partly received in a receptacle contact 20. The pin contact 18 includes a primary, radially inner conductor 40 that may be generally cylindrical with a central axis 42, and may be solid, if desired. An intermediate element 44 is received around at least part of the inner conductor 40 and is formed from a material different than the inner conductor 40. The intermediate element 44 may be tubular (e.g. annular), and have a central passage 46 defined by an inner surface 48 of a size/diameter adapted to closely fit about an outer surface 50 of the inner conductor 40. The intermediate element 44 has an outer surface 52 of a size/diameter for close receipt within a passage 53 defined by an inner surface 54 of a secondary, outer conductor 56. The outer conductor 56, in turn, has an outer surface 58 that is of a shape and size for receipt in a socket 59 of the receptacle contact 20 for electrical conduction with an inner surface 60 of the receptacle contact. The outer conductor 56 may be formed from the same material as the inner conductor 40 but could be formed from a different, electrically conductive material. The intermediate element 44 and the outer conductor 56 could be cylindrical, hollow bodies of any desired radial thickness, or they could have a different shape, like that or a toroid. In at least some implementations, the intermediate element 44 is bonded to both the inner conductor 40 and the outer conductor 56, formed from a different material than both the inner conductor 40 and outer conductor 56, and is located between and separates the inner conductor 40 and outer conductor 56 such that the conductors are not in direct, physical contact with each other.

In this example, the receptacle contact 20 is annular, with a central axis (as shown it is coaxial with the inner conductor 40, intermediate element 44 and outer conductor 56), and defines the socket 59 that is cylindrical (for example), or the receptacle contact 20 may be toroidal (by way of another non-limiting example) with an inner surface and corresponding central void shaped accordingly. The diagrammatic views of FIGS. 5 and 6 show all layers/components as being cylindrical and coaxial, with radial symmetry between the various layers/components of the contacts, but this disclosure is not limited to any specific geometry, nor any specific geometric symmetry or combination of geometries in the contacts.

In some implementations, such as that shown in FIG. 9, the intermediate element 44″ could be arranged in a receptacle contact 20″ with the primary conductor 40″ being the radially outer body and with a secondary conductor 56″ defining a radially inner body that has an inner surface 54″ that defines the socket 59″ in which a pin contact 18″ is arranged to be received. In this way, the contact pressure or force may be radially inwardly compressive to increase the contact pressure with the pin contact 18″. Of course, other arrangements providing increased contact pressure can be considered.

The material and physical properties (for example, size/shape, thickness, density) of the intermediate element 44 may be chosen to provide a desired thermal expansion to provide a desired interface between the outer conductor 56 and the socket 59 in which it is received in the receptacle contact 20. When connected and conducting current, the temperature of the contacts 18, 20 will increase and thermal expansion of the intermediate element 44 will be constrained by the conductors 40, 56, and expansion of the outer conductor 56 will be constrained by the receptacle contact 20, and compressive stresses in the contacts 18, 20 will increase with increasing current and temperature. In at least some implementations, the intermediate element 44 may be made of electrically conductive materials like metal, and in some examples may be a combination of tin and copper. The following table shows the thermophysical properties of tin and oxygen-free copper (OFC), some assumed volumetric ratios, and the resulting blended thermophysical properties assuming a simple linear law of mixtures based on volume fraction, for ease of analysis and discussion.

| | | YOUNGS | | THERMAL | THERMAL |
|---|---|---|---|---|---|
| | VOLUME | MODULUS, | POISSON | CONDUCTIVITY, | EXPANSION, |
| Material | FRACTION, % | GPa | RATIO | W/m-K | micron/m-K |
| Tin | 0.25 | 50 | 0.33 | 67 | 22 |
| OFC | 0.75 | 120 | 0.36 | 401 | 17.7 |
| Average | | 102.5 | 0.3525 | 317.5 | 18.775 |

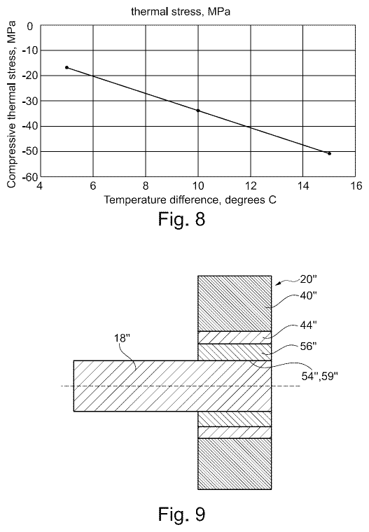

From these material properties, the estimated thermal compressive stress at the interfaces between the intermediate element 44 and the inner conductor 40 and outer conductor 56, in MPa as a function of the delta in temperature in degrees C., is shown in the graph of FIG. 8. This graph shows that a temperature difference of 10 degrees Celsius can result in a more than 30 MPa difference in compressive thermal stress. The stress level can approach the yield strength of copper, which, in some implementations, is what the inner and outer conductors 40, 56 are formed of. However, the thermal expansion layer, is a composite of tin and copper, or similar such material combinations, and has a lower yield strength and will yield first. Thus, in at least some implementations, the intermediate element 44 is formed of a material having a lower yield strength than one or both of the inner conductor 40 and the outer conductor 56.

In FIG. 7, a pin contact 18′ is shown with an intermediate element 44′ in the form of a coating applied to the outer surface of the pin contact 18′, and also with an outer conductor 56′ located outboard of the coating 44′. In this example, the coating/intermediate element 44′ and outer conductor 56′ are radially outboard of a side surface of the pin contact 18′ and also axially outboard of (e.g. covering) the axially oriented free end 30′ of the pin contact 18′. The pin contact 18′ is shown in an installed or connected stated received in a mating socket 59 of a receptacle contact 20. The inner conductor 40′, the intermediate element 44′, and the outer conductor 56′ may all be bonded together, in at least some implementations.

In this and other implementations, the inner conductor 40′, and the outer conductor 56′ could, for example, be copper alloys plated with nickel, silver, or other metals. Also, in this and other implementations, the intermediate element 44′ could be formed from stainless steel and the joint could be made, for example, ultrasonically or by controlled crimping. Stainless steel has a higher electrical resistivity than copper, almost 100 times higher in some examples, and has a thermal expansion coefficient that is similar to that of copper. Due to the higher resistivity, the stainless steel intermediate layer 44′ will be subject to higher temperature and a resulting greater thermal expansion for a given current flow. This is just one of many possible material combinations that would enable the intermediate element 44′ to thermally expand in a desired manner, in use of the electrical connector 10. Such selective heating and thermal expansion can be provided in a thin layer and result in larger contact forces, and contact forces that increase with increasing current.

In at least some implementations, there can be a favorable increase in contact pressure even with small differences in material properties. Upper limits may be determined as a function of the temperature coefficient of resistivity of materials and/or to avoid a pressure increase large enough to cause plastic deformation, at least in applications where the deformations are desired to be thermo-elastic only.

In another example, the materials used could include machinable copper, for example Cu39Zn1Pb, as the intermediate element, which has about 28% of the conductivity of pure copper, and copper may be used for the higher conductivity conductors. Machinable copper has a thermal expansion coefficient of 21.2 E−06 per degree C., whereas pure copper has a lower thermal expansion coefficient of 17 E−06. So in this example, the thermal expansion coefficient is 25% higher, whereas the electrical resistance is 3.6 times higher. In at least some implementations, the electrical conductivity of the intermediate element may be in the range of 5%-50% of the conductivity of the conductors, or that of pure copper. Further, the thermal expansion coefficient of the intermediate element maybe in a similar range of 5%-50% larger than that of the conductors, or that of pure copper.

In at least some implementations, instead of being bonded to the pin contact 18, 18′, the intermediate element 44, 44′ can be an insert or sleeve that is installed (e.g. by a slidable, friction fit or interference fit) on the pin contact and which can, if desired, be replaced each time a connection including the pin contact is made (e.g., each time the pin contact is inserted into a socket), as the insert 44, 44′ will expand and may preferentially yield to form a very low thermal resistance joint. The insert 44, 44′ could be bonded to an outer conductor 56, 56′ that is also replaced when the insert is replaced, or the insert could be separable from both the inner conductor 40, 40′ and outer conductor.

By way of non-limiting examples, the insert, and the intermediate element 44, 44′ in general, could be made from various materials, such as an amalgam of a tin matrix with copper particles, or silver particles, or other particles of higher conductivity. The intermediate element 44, 44′ could also be made from semi-solid, or thixotropic metal alloys. These are alloys that have been held in between liquidus and solidus, and then have been subjected to high shear strain, thereby breaking up the solidified dendrites and leaving behind a low meting point eutectic. This eutectic when heated then allows the spheroidized higher melting point alloy particles to slide easy and fill in very small interfacial cracks and crevasses. This will increase the conducting contact area significantly.

An example of a high temperature version of such a thixotropic alloy is aluminum-silicon, which has been held at the semi-solid point and subjected to high shear rate mixing. The resulting microstructure consists of spherical alphas aluminum particles and a low melting point terminal eutectic. Similar microstructures are possible in tin alloys, with copper particles added in as the conductive spherical particles. The particle size could be adjusted/chosen as a function of or to match the characteristic dimensions of the surface roughness features that need to be filled in, and they could even be made at a nano-scale.

In choosing material and construction/physical properties of the intermediate element 44, 44′, some factors in at least some implementations may include the resistivity of the material compared to the contact as a whole, with a goal of not adding too much high resistivity material to the contact 18, 18′ which could thereby adversely impact the overall bulk resistivity of the contact. The intermediate element 44, 44′ can do one or more of: increase the contact force between mated electrical contacts; make the contact force more consistent across a mated surface area (apparent area of contact); and provide a contact force that increases with increasing current, thereby lowering the contact resistance and providing a “self-tightening” mechanism whereby connection of the electrical contacts is improved with increasing current, at least within a range of current that occurs within given applications.

So formed, the electrical contacts described herein can help prevent localized increases in electrical contact resistance in a wide array of electrical contacts. Examples include, but are not limited to: electrical contacts in connectors; electrical contacts to bus bars, such as bolted contacts; electrical contacts involving cables with terminal lugs; connections to terminal lugs; connections to circuit breakers; and connections to motor starters. Such connections may be useful in and to connections in a wide array of components and subcomponents, including but not limited to: an electrical distribution and control cabinet, such as commonly used for industrial automation and control and machinery; power distribution, conversion, and transportation stations and substations, and all of their associated and auxiliary devices; batteries or arrays of batteries; electric vehicles of all varieties where power is distributed internally to the vehicle, for example between storage and drive components; battery storage systems whether they be at a residential, industrial, or grid level; and solar, wind, and other alternative energy generation systems.

All terms used in the claims are intended to be given their broadest reasonable construction and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

What is claimed is:

1. An electrical contact having an inner conductor, an outer conductor and an intermediate element located between the inner conductor and the outer conductor, wherein a material of the intermediate element has one or both of a higher electrical resistivity and a higher rate of thermal expansion than a material of both the inner conductor and the outer conductor.

2. The electrical contact of claim 1 wherein the material of the intermediate element has a lower yield strength than the material of the outer conductor.

3. The electrical contact of claim 1 wherein the material of the intermediate element has a lower yield strength than the material of the inner conductor.

4. The electrical contact of claim 1 wherein the intermediate element is bonded to one or both of the inner conductor and the outer conductor.

5. The electrical contact of claim 1 wherein the intermediate element is contained in an insert that is removable from the inner conductor.

6. The electrical contact of claim 1 wherein the intermediate element is formed from one or more of stainless steel, tin and copper.

7. The electrical contact of claim 6 wherein the intermediate element is formed from machinable copper with a coefficient of thermal expansion greater than that of pure copper.

8. The electrical contact of claim 1 wherein the intermediate element is tubular and has a central passage in which the inner conductor is received.

9. The electrical contact of claim 1 wherein the intermediate element is formed from a different material than both the inner conductor and outer conductor, and is located between and separates the inner conductor and outer conductor such that the conductors are not in direct, physical contact with each other.

10. The electrical contact of claim 1 wherein the intermediate element is provided in the form of a coating bonded to one or both of the inner conductor and the outer conductor.

11. The electrical contact of claim 1 wherein the intermediate element is formed from an amalgam of a tin matrix with copper particles or silver particles.

12. The electrical contact of claim 1 wherein the intermediate element is formed from semi-solid or thixotropic metal alloys.

13. The electrical contact of claim 1 wherein the intermediate element is formed from an aluminum-silicon thixotropic alloy.

14. The electrical contact of claim 1 wherein the intermediate element is formed from a tin alloy that includes spherical, copper particles.

15. The electrical contact of claim 1 wherein the material of the intermediate element has a yield strength that is 5% to 50% greater than the material of the outer conductor or the inner conductor.

16. The electrical contact of claim 1 wherein the material of the intermediate element has an electrical conductivity that is 5% to 50% lower than the material of the outer conductor or the inner conductor.

17. The electrical contact of claim 1 wherein the outer conductor is part of a receptacle contact and includes a radially inner surface against which an outer surface of the intermediate element is received.

18. A method of forming a multiple material electrical contact, comprising:
providing an outer contact that has a passage;
securing within the passage an annular intermediate element having an outer surface adjacent to a surface of the outer contact that defines the passage and an inner surface that defines a passage of the intermediate element; and
securing an inner conductor within the passage of the intermediate element, wherein a material of the intermediate element has one or both of a higher electrical resistivity and a higher rate of thermal expansion than a material of both the inner conductor and the outer conductor, wherein the inner conductor is a solid pin or is annular and defines a socket of a receptacle contact.

19. An electrical connector, comprising an electrical contact of claim 1.
